(19) United States
(12) Patent Application Publication
(10) Pub. No.: US 2009/0072459 A1
(43) Pub. Date: Mar. 19, 2009

(54) Shock absorber for a bicycle

(76) Inventor: Chin-Sung Tsai, Hsin Chuang City (TW)

Correspondence Address: CHARLES E. BAXLEY, ESQUIRE, 90 JOHN STREET, SUITE 309, NEW YORK, NY, 10038, US

(21) Appl. No.: 11/901,860

(22) Filed: Sep. 19, 2007

(51) Int. Cl. B60G 13/04

(52) U.S. Cl. 267/216

(57) ABSTRACT

A shock absorber for a bicycle is mounted between a front stem and a front fork of the bicycle, provides a damping effect and has a leading assembly and a sliding assembly. The leading assembly has a leading rod. The leading rod is mounted slidably in the tubular front stem, is attached securely to and protrudes up from the front fork and has a keyed segment. The sliding assembly is mounted securely on the front stem, is mounted slidably around the leading rod and has a bearing. The bearing is mounted rotatably in the front stem, corresponds to, engages and is mounted slidably around the keyed segment of the leading rod. Consequently, having the keyed segment and the bearing corresponding to and engaging each other allows the shock absorber to reduce vibration and react promptly while the bicycle is ridden.

### BACKGROUND OF THE INVENTION

1. Field of the Invention

The present invention relates to a shock absorber for a bicycle, especially to a shock absorber mounted between the front stem and the front fork of the bicycle.

2. Description of the Prior Arts

A conventional shock absorber for a bicycle having a tubular front stem and a front fork provides a damping effect, is mounted between the tubular front stem and the front fork of the bicycle and has a leading rod. The leading rod is cylindrical, is mounted between the front stem and the front fork, is attached securely to and protrudes up from the front fork and has an upper end. The upper end of the leading rod is mounted slidably in the front stem and slides a distance to enable the damping effect.

However, when a gap is formed between the leading rod and the front stem, the bicycle will vibrate when ridden on a rough surface. Moreover, when the leading rod fits too tightly in the front stem, friction between the leading rod and the front stem slows down reaction time of the shock absorber, and the comfort of riding the bicycle is decreased.

The present invention provides a shock absorber for a bicycle to mitigate or obviate the aforementioned problems.

### SUMMARY OF THE INVENTION

The main objective of the present invention is to provide a shock absorber for a bicycle having a tubular front stem and a front fork, which reduces vibration and reacts quickly when the bicycle is ridden.

The shock absorber for a bicycle in accordance with the present invention is mounted between the front stem and the front fork of the bicycle, provides a damping effect and has a leading assembly and a sliding assembly. The leading assembly has a leading rod. The leading rod is mounted slidably in the tubular front stem, is attached securely to and protrudes up from the front fork and has a sidewall and a keyed segment. The keyed segment is formed on the sidewall. The sliding assembly is mounted securely on the front stem, is mounted slidably around the leading rod and has a bearing. The bearing is mounted rotatably in the front stem, corresponds to, engages and is mounted slidably around the keyed segment of the leading rod. Consequently, having the keyed segment and the bearing corresponding to and engaging each other reduces vibration and reaction time of the shock absorber while the bicycle is ridden.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a shock absorber in accordance with the present invention for a bicycle having a front stem and a front fork mounted between the front stem and the front fork;

FIG. 2 is an exploded perspective view of the shock absorber in FIG. 1;

FIG. 3 is a side view in partial section of the shock absorber in FIG. 1;

FIG. 4 is an exploded perspective view of a needle bearing in the shock absorber in FIG. 3;

FIG. 5 is a cross-sectional side view of the bearing in FIG. 4;

FIG. 6 is an operational side view in partial section of the shock absorber in FIG. 1 with the shock absorber compressed;

FIG. 7 is an exploded perspective view of another embodiment of the shock absorber for a bicycle in accordance with the present invention;

FIG. 8 is a side view in partial section of the shock absorber in FIG. 7; and,

FIG. 9 is an operational side view in partial section of the shock absorber in FIG. 7 with the shock absorber compressed.

### DETAILED DESCRIPTION OF THE PREFERRED EMBODIMENTS

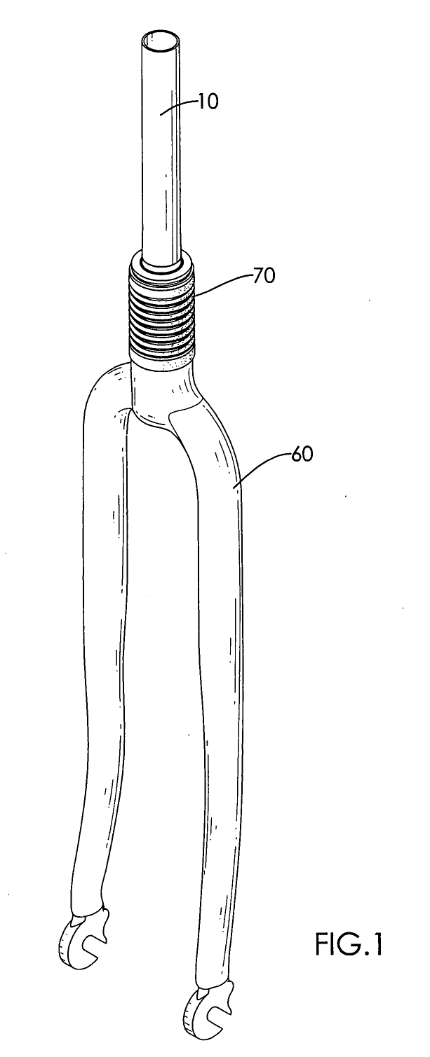

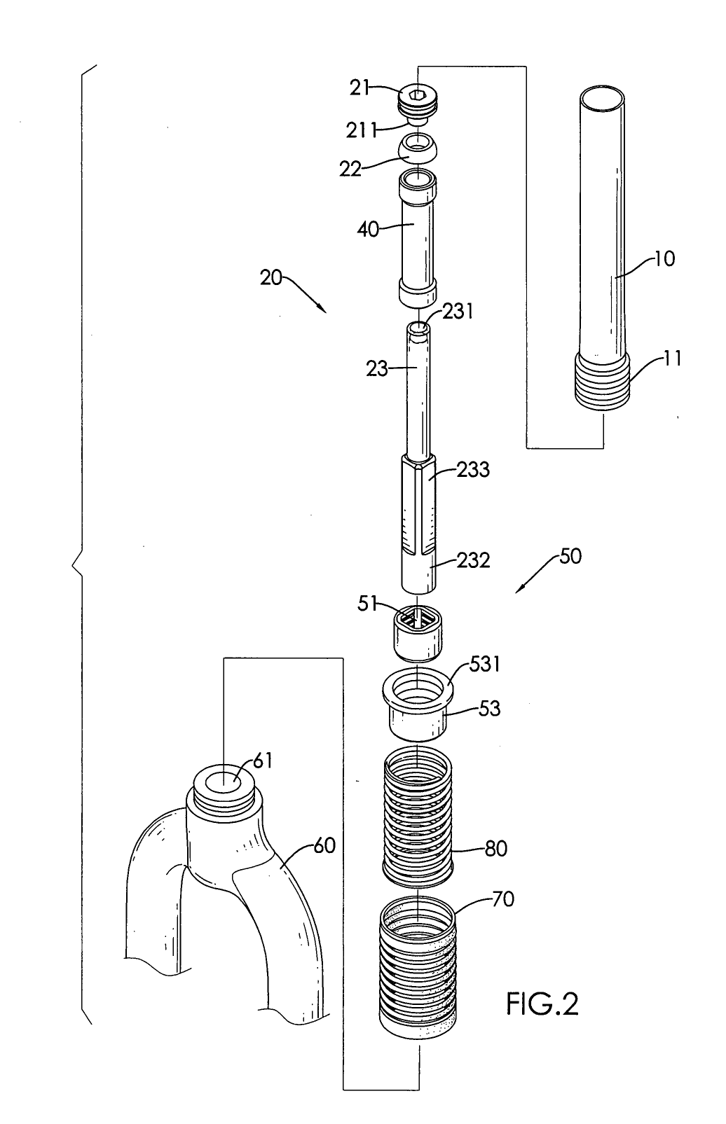

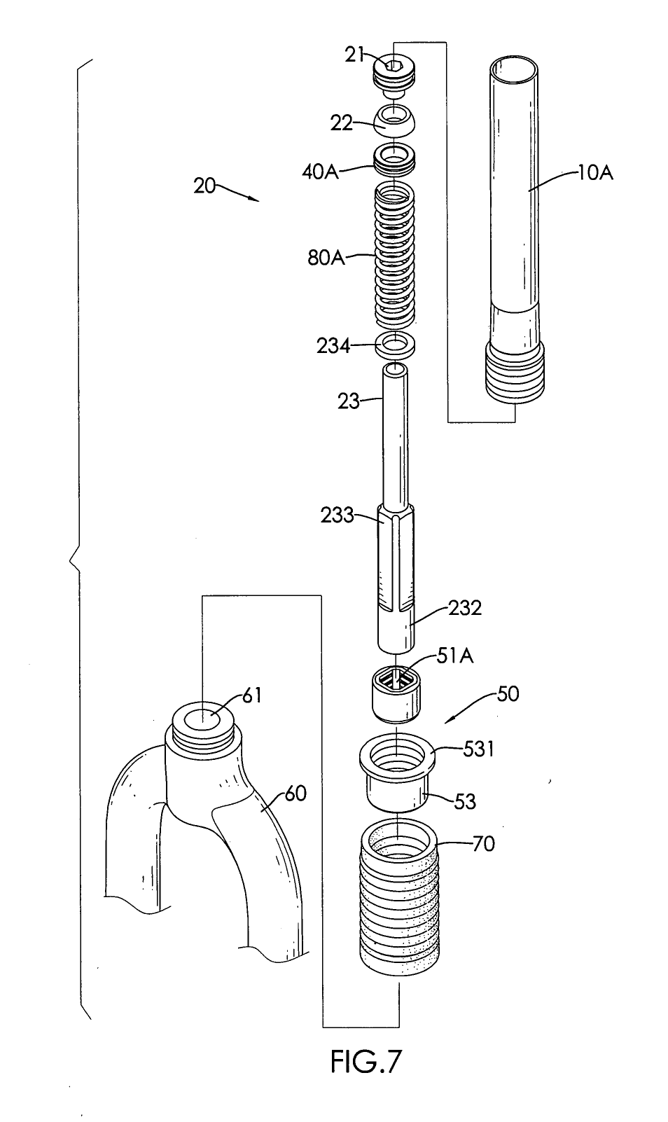

With reference to FIGS. 1, 2 and 7, a shock absorber in accordance with the present invention for a bicycle having a handlebar, a front stem (10) and a front fork (60) is mounted between the front stem (10) and the front fork (60), provides a damping effect for the bicycle and comprises a leading assembly (20), a sliding assembly (50), a stop (40, 40A), a spring (80, 80A) and an optional dust cover (70).

The front stem (10) is tubular, is mounted below the handlebar and has an inside wall, a lower end and a barrel (11). The barrel (11) is formed in the lower end of the front stem (10) by expanding the lower end of the front stem (10) and has an outside wall. The outside wall of the barrel (11) may be threaded.

The front fork (60) has an upper end and a mounting hole (61). The mounting hole (61) is formed in the upper end of the front fork (60).

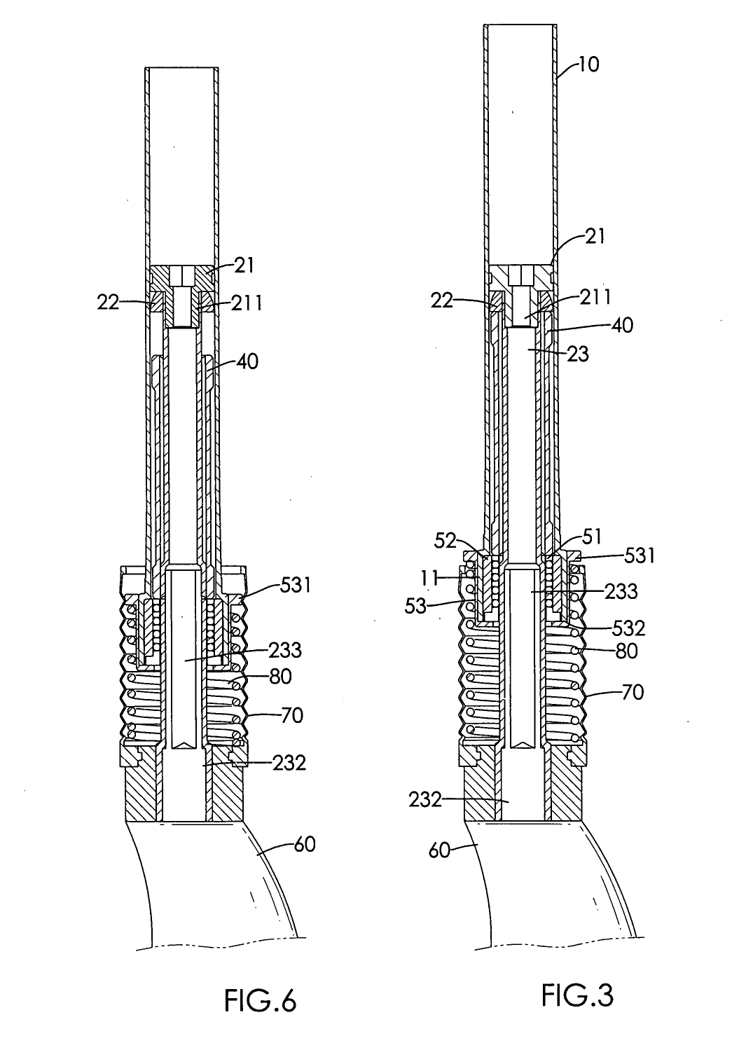

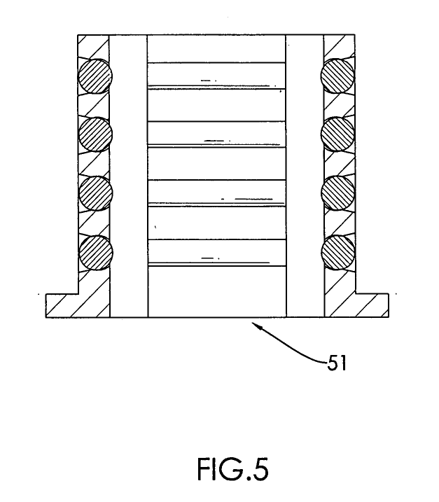

With further reference to FIGS. 3 and 6, the leading assembly (20) is mounted slidably in the tubular front stem (10), is attached securely to the front fork (60) and has a leading rod (23), a limit (21) and a gasket (22).

The leading rod (23) is mounted slidably in the front stem (10), is attached securely to the upper end of the front fork (60) and has a lower end, an upper end, a sidewall, an optional mounting recess (231), an optional mounting segment (232), a keyed segment (233) and an optional pressing ring (234).

The mounting recess (231) is formed in the upper end of the leading rod (23) and may be threaded.

The mounting segment (232) is formed on the lower end of the leading rod and corresponds to and is mounted securely in the mounting hole (61) of the front fork (60).

The keyed segment (233) is formed on the sidewall of the leading rod (233) near the lower end and has an upper end.

The pressing ring (234) is mounted around the leading rod (23) and is mounted on the upper end of the keyed segment (233).

The limit (21) is attached securely to the upper end of the leading rod (23), corresponds to and is mounted slidably inside the front stem (10) and has a bottom surface and an optional neck (211). The neck (211) of the limit (21) is formed coaxially on and protrudes from the bottom surface of the limit (21), is threaded and is correspondingly mounted securely in the mounting recess (231).

The gasket (22) is mounted securely around the leading rod (23) against the bottom surface of the limit (21).

The sliding assembly (50) is mounted securely on the front stem (10), is mounted slidably around the leading rod (23) and has a bearing (51) and a mounting cap (53).

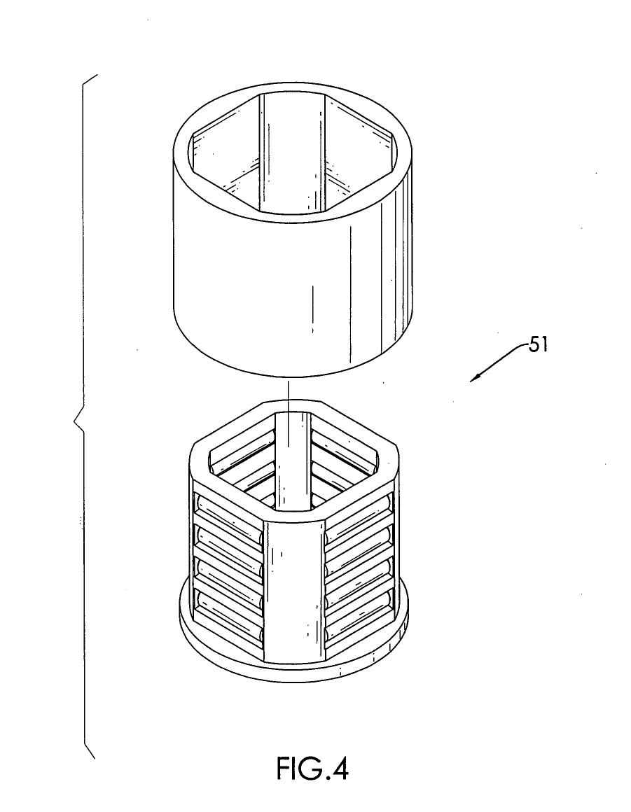

With further reference to FIGS. 4 and 5, the bearing (51) is mounted rotatably in the barrel (11) of the front stem (10), corresponds to, engages and is mounted slidably around the keyed segment (233) of the leading rod (23), may be a needle bearing (51).

The mounting cap (53) is mounted securely around the barrel (11), carries the bearing (51) to mount the bearing (51) inside the barrel (11), is mounted slidably around the leading assembly (20) and has a through hole, an inner surface, an outer surface and an optional flange (531). The through hole of the mounting cap (53) is formed through the mounting cap (53) and is mounted slidably around the leading assembly (20). The inner surface of the mounting cap (53) may be threaded and is screwed securely on the outside wall of the barrel (11). The flange (531) is formed on and extends transversely from the outer surface of the mounting cap (53).

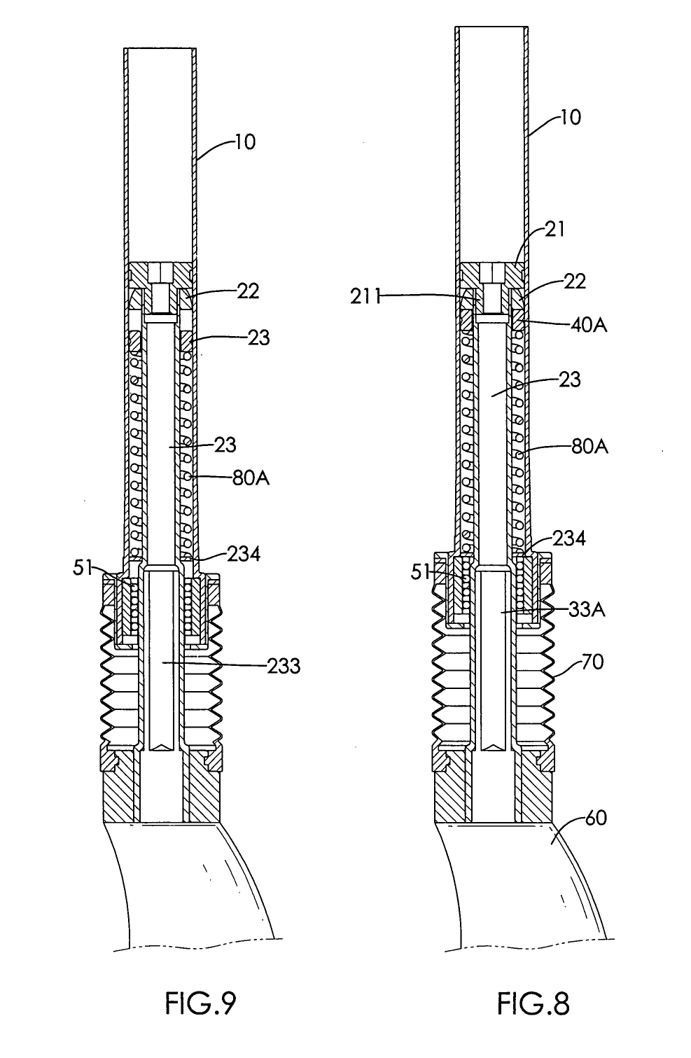

With further reference to the FIGS. 8 and 9, the stop (40, 40A) is mounted in the front stem (10), selectively stops the front stem (10) from moving upwards relative to the front fork (60), is mounted slidably around the leading rod (23) and selectively abuts the gasket (22). The stop (40) may be a cylinder tube and may abut the bearing (51), or the stop (40A) may be a cylinder ring and may be mounted securely on the inside wall of the front stem (10).

The spring (80, 80A) presses between the leading assembly (20) and the sliding assembly (30) to provide a damping effect for the bicycle. The spring (80) may be mounted between and press against the flange (531) of the mounting cap (53) and the upper end of the front fork (60), or the spring (80A) may be mounted in the front stem (10), may be mounted between and may press against the stop (40A) and the pressing ring (234).

The dust cover (70) is connected between the flange (531) of the mounting cap (53) and the upper end of the front fork (60).

Consequently, having the keyed segment (233) of the leading rod (23) and the bearing (51) corresponding and engaging with each other prevents the bicycle from vibrating during riding on a rough surface. Moreover, applying the bearing (51) on the bicycle reduces friction of contact between the leading assembly (20) and the sliding assembly (50) such that allows the shock absorber to react more promptly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A shock absorber for a bicycle comprising
a leading assembly having
a leading rod having
a lower end;
an upper end;
a sidewall; and
a keyed segment being formed on the sidewall of the leading rod near the lower end and having an upper end;
a limit being attached securely to the upper end of the leading rod and having a bottom surface; and
a gasket being mounted securely around the leading rod against the bottom surface of the limit;
a sliding assembly being mounted slidably around the leading rod and having
a bearing corresponding, engaging and being mounted slidably around the keyed segment of the leading rod; and
a mounting cap carrying the bearing, being mounted slidably around the leading assembly and having
a through hole being formed through the mounting cap and being mounted slidably around the leading assembly;
an inner surface; and
an outer surface;
a stop being mounted slidably around the leading rod and selectively abutting the gasket; and
a spring pressing between the leading assembly and the sliding assembly.

2. The shock absorber for a bicycle as claimed in claim 1, wherein
the mounting cap of the sliding assembly further has a flange being formed on and extending transversely from the outer surface of the mounting cap;
the stop is a cylinder tube and abuts the bearing; and
the spring is mounted beneath and presses against the flange of the mounting cap.

3. The shock absorber for a bicycle as claimed in claim 1, wherein
the leading rod further has a pressing ring being mounted around the leading rod and being mounted on the upper end of the keyed segment;
the stop is a cylinder ring; and
the spring is mounted between and presses against the stop and the pressing ring.

4. The shock absorber for a bicycle as claimed in claim 2, wherein the leading rod further has
a mounting recess being formed in the upper end of the leading rod and being threaded; and
a mounting segment being formed on the lower end of the leading rod; and
the limit further has a neck being formed coaxially on and protruding from the bottom of the limit, being threaded and being correspondingly mounted securely in the mounting recess of the leading rod.

5. The shock absorber for a bicycle as claimed in claim 4, wherein the bearing is a needle bearing.

6. The shock absorber for a bicycle as claimed in claim 5 further comprising a dust cover being connected on the mounting cap.

7. The shock absorber for a bicycle as claimed in claim 6, wherein the inner surface of the mounting cap is threaded.

8. The shock absorber for a bicycle as claimed in claim 3, wherein the leading rod further has
a mounting recess being formed in the upper end of the leading rod and being threaded; and
a mounting segment being formed on the lower end of the leading rod; and
the limit further has a neck being formed coaxially on and protruding from the bottom of the limit, being threaded and being correspondingly mounted securely in the mounting recess of the leading rod.

9. The shock absorber for a bicycle as claimed in claim 8, wherein the bearing is a needle bearing.

10. The shock absorber for a bicycle as claimed in claim 9 further comprising a dust cover being connected on the mounting cap.

11. The shock absorber for a bicycle as claimed in claim 10, wherein the inner surface of the mounting cap is threaded.
